(19) United States
(12) Patent Application Publication
(10) Pub. No.: US 2025/0278467 A1
(43) Pub. Date: Sep. 4, 2025

(54) INFORMATION PROCESSING OF FEATURE DATA

(71) Applicant: TENCENT TECHNOLOGY (SHENZHEN) COMPANY LIMITED, Shenzhen (CN)

(72) Inventors: Zhongwang JIN, Shenzhen (CN); Jinkun HOU, Shenzhen (CN); Runzeng GUO, Shenzhen (CN); Shaoming WANG, Shenzhen (CN); Jianzhong LI, Shenzhen (CN); Guitao ZHENG, Shenzhen (CN); Hongda LIU, Shenzhen (CN)

(73) Assignee: TENCENT TECHNOLOGY (SHENZHEN) COMPANY LIMITED, Shenzhen (CN)

(21) Appl. No.: 19/209,702

(22) Filed: May 15, 2025

Related U.S. Application Data
(63) Continuation of application No. PCT/CN2024/086533, filed on Apr. 8, 2024.

(30) Foreign Application Priority Data
Apr. 18, 2023 (CN) 202310458532.9

(51) Int. Cl. G06F 21/32; G06V 40/12; G06V 40/13

(52) U.S. Cl. CPC G06F 21/32; G06V 40/13; G06V 40/1365

(57) ABSTRACT

In an information processing method, a first event is inserted by an first application framework in response to an interface invocation request from a first application into an event interface. The first event is generated based on the interface invocation request. The event interface corresponds to an operating system in a feature recognition device. The first application framework is configured to provide a running environment for the first application. Object identity information is provided, by the first application framework, from the event interface to the first application. The object identity information corresponds to feature data that is obtained by a second application based on event information of the first event.

### RELATED APPLICATIONS

The present is a continuation of International Application No. PCT/CN2024/086533, entitled “INFORMATION PROCESSING METHOD AND APPARATUS, ELECTRONIC DEVICE, STORAGE MEDIUM, AND PROGRAM PRODUCT” and filed on Apr. 8, 2024, which claims priority to Chinese Patent Application No. 202310458532.9, entitled “INFORMATION PROCESSING METHOD AND APPARATUS, ELECTRONIC DEVICE, STORAGE MEDIUM, AND PROGRAM PRODUCT” and filed on Apr. 18, 2023. The entire disclosures of the prior applications are hereby incorporated by reference.

### FIELD OF THE TECHNOLOGY

This disclosure relates to the field of feature recognition technologies, including to an information processing method and apparatus, an electronic device, a storage medium, and a program product.

### BACKGROUND OF THE DISCLOSURE

A current feature recognition device can provide a feature recognition capability and subsequent particular services, such as a payment service and a check-in service. After a user enters a to-be-recognized feature on the device and the feature is successfully recognized, the user can open a service program of a device access party, and further complete a behavior such as identity login (for example, scanning a code to log in).

As long as the user can successfully log in to the service program, all subsequent interactions between the user and the feature recognition device can be completed by using the service program.

### SUMMARY

According to an aspect of the embodiments of this disclosure, an information processing method is provided. In an example, the information processing method is performed by a feature recognition device. A first application and a second application are run in the feature recognition device, a first application framework is provided, and the first application framework provides a running environment of the first application.

In an aspect, an information processing method is provided. In the information processing method, a first event is inserted by an first application framework in response to an interface invocation request from a first application into an event interface. The first event is generated based on the interface invocation request. The event interface corresponds to an operating system in a feature recognition device. The first application framework is configured to provide a running environment for the first application. Object identity information is provided, by the first application framework, from the event interface to the first application. The object identity information corresponds to feature data that is obtained by a second application based on event information of the first event.

According to another aspect of the embodiments of this disclosure, an information processing apparatus is provided. In an example, the information processing apparatus runs on a feature recognition device. A first application and a second application are run in the feature recognition device, a first application framework is provided, and the first application framework provides a running environment of the first application.

In an aspect, an information processing apparatus includes processing circuitry. The processing circuitry is configured to insert, via an first application framework in response to an interface invocation request from a first application, a first event generated based on the interface invocation request into an event interface corresponding to an operating system in a feature recognition device. The first application framework is configured to provide a running environment for the first application. The processing circuitry is configured to provide, via the first application framework, object identity information from the event interface to the first application. The object identity information corresponds to feature data that is obtained by a second application based on event information of the first event.

According to another aspect of the embodiments of the disclosure, a non-transitory computer-readable storage medium is provided. The non-transitory computer-readable storage medium stores instructions which, when executed by a processor, cause the processor the perform any of the methods described herein.

### BRIEF DESCRIPTION OF DRAWINGS

To describe the technical solutions in the embodiments of this disclosure more clearly, the following briefly describes the accompanying drawings.

FIG. 1a is a schematic diagram of using an Internet of things (IoT) mini program of a device access party in a palm scanning device.

FIG. 1b is a schematic diagram of logging in to an IoT mini program by scanning a code.

FIG. 2a is a schematic flowchart of an information processing method according to an embodiment of this disclosure.

FIG. 2b is a schematic flowchart of an information processing method according to an embodiment of this disclosure.

FIG. 3a is a schematic diagram of an implementation of a ContentProvider according to an embodiment of this disclosure.

FIG. 3b is another schematic diagram of an implementation of a ContentProvider according to an embodiment of this disclosure.

FIG. 4 is a schematic diagram of a data transmission effect of identity information according to an embodiment of this disclosure.

FIG. 5 is a schematic diagram of a structure standard of a URI according to an embodiment of this disclosure.

FIG. 6 is a schematic diagram of a complete invoking process from an IoT mini program that is run in a wechat mini program framework (WMPF) to a palm scanning disclosure (APP) according to an embodiment of this disclosure.

FIG. 7 is a schematic diagram of a structure of an information processing apparatus according to an embodiment of this disclosure.

FIG. 8 is a schematic diagram of a structure of an electronic device according to an embodiment of this disclosure.

### DESCRIPTION OF EMBODIMENTS

The following describes embodiments of this disclosure with reference to the accompanying drawings of this disclosure. The implementations described below with reference to the accompanying drawings are example descriptions used for explaining the technical solutions of the embodiments of this disclosure, and do not constitute a limitation on the technical solutions of the embodiments of this disclosure.

A person skilled in the art may understand that, unless specifically stated, singular forms “a/an”, “one”, and “the” used herein may also include plural forms. The terms “comprise” and “include” used in the embodiments of this disclosure refer to corresponding features that can be implemented as presented features, information, data, steps, operations, elements, and/or components, but do not exclude the implementation as other features, information, data, steps, operations, elements, components, and/or combinations thereof supported in the art. When an element is referred to as “connected” or “coupled” to another element, the element may be directly connected or coupled to the another element, or a connection relationship is established between the element and the another element through an intermediate element. In addition, the “connected” or “coupled” used herein may include wireless connection or wireless coupling. The term “and/or” used herein indicates at least one of the items defined by the term. For example, “A and/or B” indicates an implementation as “A”, an implementation as “B”, or an implementation as “A and B”.

In order to make the objectives, technical solutions, and advantages of this disclosure clearer, the following further describes the implementations of this disclosure with reference to the accompanying drawings.

First, several terms included in this disclosure are introduced and explained. The descriptions of the terms are provided as examples only and are not intended to limit the scope of the disclosure.

(1) Palm scanning: In a case of no contact, a user only needs to stretch out a palm, so that a recognition device can perform recognition, to authenticate a user identity. A palm scanning technology may rely on palm print recognition, vein recognition, and the like, but are not limited thereto.

(2) A feature recognition device: The feature recognition device is an offline feature recognition terminal (for example, a palm scanning device, a face scanning device, or a fingerprint scanning device), and a user may complete a process of feature recognition (for example, palm recognition, face recognition, or fingerprint recognition) on the device, and perform a subsequent specific operation, for example, a payment operation or a check-in operation, but is not limited thereto.

(3) Feature recognition service: After the user activates a feature recognition service on the feature recognition device, the feature recognition service is bound to a unique account specified by the user.

(4) Device access party: The device access party is a third-party access party of the feature recognition service, for example, a large supermarket or an enterprise. The device access party develops, based on a service provided by the feature recognition device, a service program that is run on the feature recognition device. In this case, the device access party may alternatively be considered as a service program developer.

(5) IoT mini program: The IoT mini program is a mini program that can be run on a hardware device departing from a predetermined application environment.

(6) Mini program framework (MPF): The MPF, such as the Wechat mini program framework (WMPF), is an IoT mini program hardware framework, and is a framework configured to carry and run the IoT mini program. To meet a demand for using a mini program on a non-universal computing device, a mini program hardware framework emerges. As a running environment, the WMPF enables a hardware device (the non-universal computing device such as the feature recognition device) to run a mini program in the absence of a condition for running a predetermined application client such as a wechat client.

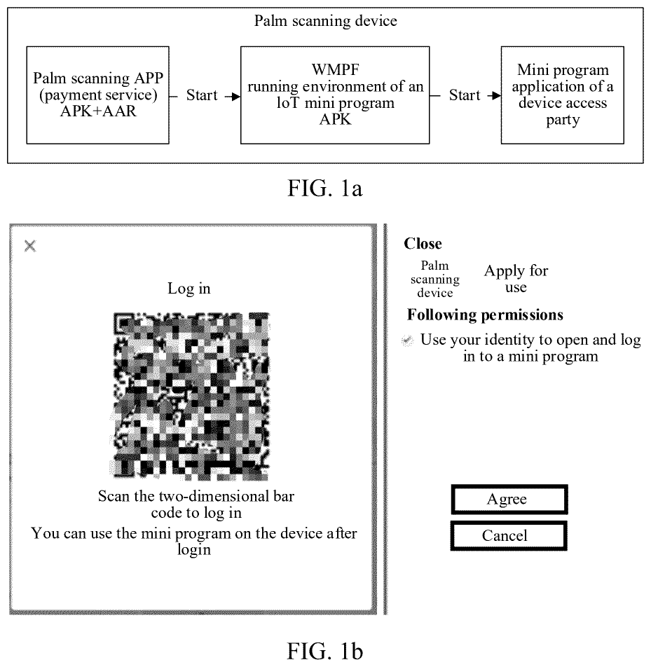

In a current feature recognition device, a device access party may carry a service of the device access party by using a service program, and use a feature recognition-related capability of the feature recognition device. An example in which the feature recognition device is a palm scanning device, and a service program developed by the device access party is an IoT mini program is used. An overall application mode of using the IoT mini program of the device access party to carry a service of the palm scanning device may be roughly described as a process shown in FIG. 1a.

On the palm scanning device, a palm scanning application (APP) developed by a provider of the palm scanning device is used as a starting point, and the palm scanning application provides a core palm recognition capability and a payment service (or may be another service, and in this example, the payment service is used as an example for description). In some embodiments, the palm scanning APP may be run in a form of an Android application package (APK), or may be integrated in a form of an Android archive (AAR). After a user scans a palm on the palm scanning device and a palm print is successfully recognized by the palm scanning APP, the user can further start a service mini program of the device access party. In some embodiments, the service mini program of the device access party may be run in a form of the IoT mini program. The palm scanning APP may first start the WMPF, and then the WMPF starts the IoT mini program of the device access party. The WMPF is a running environment of the IoT mini program, and may run in a form of the APK. Then, after the palm is scanned, the user can complete a behavior such as log in by using the opened mini program on the palm scanning device. In some embodiments, login may be performed in a code-scanning manner shown in FIG. 1b, that is, login may be performed through scanning of a two-dimensional bar code. The palm scanning device applies to use an identity of the user to open and log in to the mini program, and the mini program on the palm scanning device can be used after the user agrees login. Alternatively, login may be performed in another manner, for example, inputting an account number, a password, or a verification code.

Such a link is feasible in a related case. As long as the user can successfully open the mini program, all subsequent operations and interactions of the user can be completed in the mini program. However, because a feature recognition process and a service program login process are separate, and the user further needs to complete identity login again after entering a to-be-recognized feature, which is complex in operation and affects user experience, this mini program login manner has the following two defects:

(1) The mini program cannot obtain an identity of a palm-scanning user. For example, the user is likely to have a plurality of accounts, and one of the accounts is bound to a palm scanning service. The mini program cannot ensure that the user performs login by using the account bound to the palm scanning service. This may cause a key problem: The mini program cannot ensure that an account of the palm-scanning user is the same as an account through which the person continues to use the mini program after the palm scanning. In this case, the mini program cannot further provide a reliable service.

(2) After the palm is scanned, the user further needs to scan a code again to complete identity login. Operations are complex, and user experience is affected.

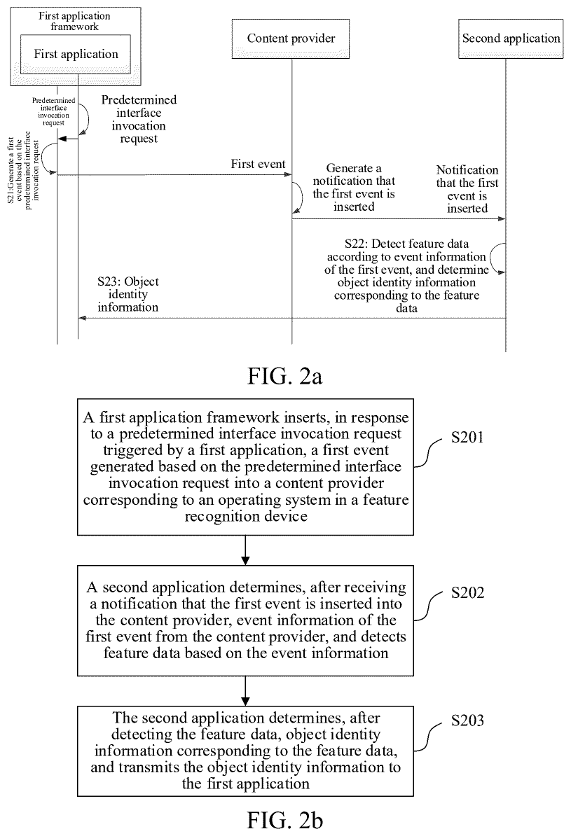

An information processing method and apparatus, an electronic device, a computer-readable storage medium, and a computer program product are provided in this disclosure. As shown in FIG. 2a, the information processing method includes the following operations: Operation S21: A first application framework inserts, in response to a predetermined interface invocation request triggered by a first application, a first event generated based on the predetermined interface invocation request into a content provider corresponding to an operating system in the feature recognition device. Operation S22: A second application determines, after receiving a notification that the first event is inserted and that is generated in the content provider, event information of the first event from the content provider, and detects feature data based on the event information. Operation S23: The second application determines, after detecting the feature data, object identity information corresponding to the feature data, and transmits the object identity information to the first application. The above technical problems in the related art can be resolved by using the information processing method.

The following describes, through descriptions of several example implementations, the technical solutions of the embodiments of this disclosure and technical effects achieved by the technical solutions of this disclosure. The following implementations may be referred to or combined with each other, and descriptions of the same terms, similar features, and similar implementation operations in different implementations are not be repeated again.

An embodiment of this disclosure provides an information processing method, performed by a feature recognition device. A first application and a second application are run in the feature recognition device, a first application framework is provided, and the first application framework provides a running environment of the first application. As shown in FIG. 2b, the method includes the following operations.

Operation S201: The first application framework inserts, in response to a predetermined interface invocation request triggered by the first application, a first event generated based on the predetermined interface invocation request into a content provider corresponding to an operating system in the feature recognition device. In an example, a first event generated based on the interface invocation request is inserted, by an first application framework in response to an interface invocation request from a first application, into an event interface corresponding to an operating system in a feature recognition device. The first application framework is configured to provide a running environment for the first application

In this embodiment of this disclosure, the first application refers to a service program carrying a service of a device access party, for example, may be an IoT mini program or may be an APP, a web page, or the like, but is not limited thereto.

The first application framework is a framework carrying and running the first application. For example, if the first application is the IoT mini program, the first application framework may be a WMPF, but is not limited thereto.

In this embodiment of this disclosure, after a user enters feature data into the feature recognition device, for example, after a palm of the user is scanned on a palm scanning device, the first application that is run in the feature recognition device triggers the predetermined interface invocation request, and transmits the predetermined interface invocation request to the first application framework.

In response to the predetermined interface invocation request, the first application framework generates the first event based on the predetermined interface invocation request, and inserts the first event into the content provider corresponding to the operating system in the feature recognition device. Specifically, the first application framework encapsulates invocation for a predetermined interface by the first application into event information, to obtain the first event, and then inserts the first event into the content provider. An encapsulation structure of the event information is roughly divided into three parts: an event name, an event unique identifier, and an event parameter. The event name is determined based on the predetermined interface invocation request, and indicates the first event. The event unique identifier indicates information that is related to the currently entered feature data and that is about the first event, and is configured for distinguishing between feature data entered at different time into the same feature recognition device. The event parameter indicates a parameter required for subsequent processing of the first event.

The content provider can provide a uniform interface for accessing application data for another application program to invoke, and allow the application data of the content provider to be exposed to the another application program for query, insertion, update, or deletion according to a requirement, without worrying about a security problem caused by directly opening a database permission.

An example in which the feature recognition device is a hardware device carrying an Android system is used. The content provider corresponding to the operating system in the feature recognition device may refer to a ContentProvider as one of four components of the Android system. Specifically, the ContentProvider specific in the Android is used as an underlying bridge, and a capability of the first application of the device access party to obtain object identity information from a feature recognition service side is implemented through a predetermined interface (used by the first application to obtain the object identity information corresponding to the feature data) protocol agreed on with the first application framework.

Operation S202: The second application determines, after receiving a notification that the first event is inserted into the content provider, event information of the first event from the content provider, and detects the feature data based on the event information.

In this embodiment of this disclosure, after the first application framework inserts the first event into the content provider, the content provider generates a notification that the first event is inserted, and transmits the notification to the second application, to notify the second application that the first event is inserted.

After receiving the notification that the first event is inserted from the content provider, the second application may extract the event information of the first event from the content provider according to the inserted first event, determine, according to the event unique identifier in the event information, feature data corresponding to the event unique identifier, and start detecting the feature data entered by the user. The feature data may include: palm scanning data such as palm print data and/or vein data, face feature data, or fingerprint data.

Operation S203: The second application determines, after detecting the feature data, object identity information corresponding to the feature data, and transmits the object identity information to the first application. In an example, the object identity information corresponding to feature data that is obtained by a second application based on event information of the first event is provided, by the first application framework, object identity information from the event interface to the first application.

In some embodiments of this disclosure, after the user enters the feature data, the second application may detect the feature data. After detecting the feature data, the second application determines the object identity information corresponding to the feature data. After the object identity information of the user that currently enters the feature data is obtained, it indicates that feature recognition on the current user succeeds.

In this embodiment of this disclosure, the obtained object identity information may be specifically an identity or identifier (ID) of the current user in case of a feature recognition service. In some embodiments, if the feature recognition service is associated with a predetermined application, the object identity information may be an OpenID of a user of predetermined software in case of a product of the feature recognition service. During actual application, the user of the predetermined software has a unique OpenID when accessing different mini programs, mobile applications, website applications, small stores, and the like, but OpenIDs generated when the same user accesses different products are different. Therefore, for the feature recognition service, an OpenID of each user is also unique.

In this embodiment of this disclosure, after obtaining the object identity information of the user that enters the feature data, the second application transmits the object identity information to the first application, to log in to the first application by using the object identity information.

In other words, the first application can actively obtain the object identity information from the current feature data recognized by the feature recognition service side merely by invoking a predetermined interface (namely, triggering the predetermined interface invocation request), without relying on a user to manually scan a code again to complete login.

The first application is logged in to by using the information processing method provided in this embodiment of this disclosure, to overcome defects in the related art, and achieve the following two technical effects:

(1) The first application can accurately obtain, through the predetermined interface, the object identity information of the user that enters the feature data, to ensure that the object identity information of the user that enters the feature data and object identity information of a user that subsequently uses the first application are the same account, so that leakage of personal information of the user can be avoided, thereby ensuring personal information security, and avoiding palm scanning failure caused by an error in obtaining the identity information of the user. Therefore, the first application can further provide a more reliable service.

(2) For the user, an operation of performing identity login again after the user enters the feature data is omitted, thereby greatly simplifying an operation process of the user and optimizing use experience of the user.

In this embodiment of this disclosure, to enable the first application to directly and actively obtain the object identity information of the user that enters the feature data, a communication bridge between the first application and the second application providing the feature recognition service is provided, that is, the content provider corresponding to the operating system in the feature recognition device is provided.

For the feature recognition device based on the Android system, the ContentProvider in the Android can also deal well with such a demand of “cross-APP” “data sharing”. Therefore, using the ContentProvider as the communication bridge in the feature recognition device based on the Android system has high feasibility.

A feasible implementation of achieving the objective in this embodiment of this disclosure is described below by using the ContentProvider in the Android system as an example.

The ContentProvider is a component in the Android, and is configured to share data. The ContentProvider may enable an application to provide an interface for accessing data of the application to another application, to implement cross-application data sharing.

Implementation operations of the ContentProvider are as follows:

1: Extend a ContentProvider class and implement an abstract method of the ContentProvider class.

2: Register the ContentProvider in an Android system manifest file.

3: During implementation of the ContentProvider, an application recognizes, through uniform resource identifier (URI) matching, requests that are to be processed by the ContentProvider.

The URI is one type of a uniform resource identifier, and is configured for identifying data provided by the ContentProvider.

4: During implementation of the ContentProvider, the application may implement methods such as query ( ), insert ( ), update ( ), and delete ( ).

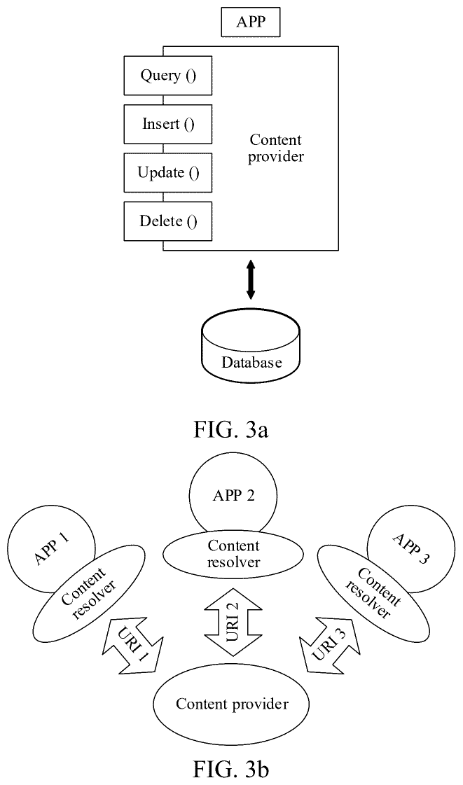

These methods are configured for processing different request types, for example, operations such as query, insertion, update, and deletion on a database, as shown in FIG. 3a.

5: During implementation of the ContentProvider, package data by using a specific data object (ContentValues) and return the data to a requester.

6: During implementation of the ContentProvider, the application may access the data in the ContentProvider by using a specific access object (ContentResolver).

The ContentResolver is a class provided by the Android system, and is configured to interact with the ContentProvider. The operations such as query, insertion, update, and deletion may be controlled by using a method of the ContentResolver, as shown in FIG. 3b.

Data sharing is implemented by using the ContentProvider, so that cross-application data sharing may be implemented, and data security and privacy are ensured. In addition, data of the application can be more easily accessed and used by another application by using the ContentProvider, thereby improving scalability of the application.

In this embodiment of this disclosure, for operation S201, the first application framework performs an insert ( ) operation on the content provider, and inserts the first event into the content provider, to achieve a query effect on object identity information in the database. Because the object identity information is not directly queried in the database, but is queried by the second application by using a feature recognition result, the insertion operation may trigger a notification that the second application performs a corresponding operation, so that an objective of transmitting the queried object identity information to the first application (operation S203) is achieved.

In this embodiment of this disclosure, the “transmitting the object identity information to the first application” in operation S203 may specifically include the following operations:

Operation S2031: The second application inserts a second event generated based on the object identity information into the content provider.

In this embodiment of this disclosure, after successfully recognizing the current feature data of the user and obtaining the object identity information corresponding to the current feature data of the user, the second application generates the second event based on the object identity information, and inserts the second event into the content provider.

Operation S2032: The first application framework extracts, after receiving a notification that the second event is inserted into the content provider, the object identity information from the second event, and transmits the object identity information to the first application.

In this embodiment of this disclosure, after the second application inserts the second event into the content provider, the content provider generates a notification that the second event is inserted, and transmits the notification to the first application framework, to notify the first application framework that the second event is inserted.

After receiving the notification that the second event is inserted into the content provider, the first application framework may extract the object identity information according to the second event inserted into the content provider, and transmit the obtained object identity information to the first application, to log in to the first application by using the object identity information.

In this embodiment of this disclosure, for operation S2031, the second application performs an insert ( ) operation on the content provider, and inserts the second event into the content provider, to achieve a data transmission effect of the object identity information queried in the database, as shown in FIG. 4. Because the object identity information is passively received by the first application framework, the insertion operation may be configured for triggering a notification that the first application framework performs a corresponding operation, so that an objective of receiving the object identity information and transmitting the object identity information to the first application (operation S2032) is achieved.

This embodiment of this disclosure provides an implementation for the second application to perform operation S203, which may specifically include: The second application determines, after detecting the feature data, the object identity information corresponding to the feature data, calls back the first application, and transmits the object identity information to the first application.

In this embodiment of this disclosure, the first application may provide a callback interface. After the first application initiates the predetermined interface invocation request to invoke the predetermined interface, the callback interface is also invoked. Specifically, when transmitting the object identity information to the first application, the second application may call back the first application through the callback interface provided by the first application, and transmit the object identity information to the first application.

With reference to at least one of the foregoing embodiments, the object identity information is transmitted to the first application through the first application framework. Operation S2032 may include: The first application framework extracts, after receiving the notification that the second event is inserted into the content provider, the object identity information from the second event, calls back the first application through the callback interface, and transmits the object identity information to the first application.

In this embodiment of this disclosure, after the predetermined interface agreed by the first application framework is invoked, the callback interface of the first application is also invoked. Specifically, after extracting the object identity information from the second event, the first application framework may call back the first application through the callback interface provided by the first application, and transmit the object identity information to the first application.

This embodiment of this disclosure provides a feasible implementation for operation S201, which may specifically include the following operations: The first application framework encapsulates invocation for the predetermined interface by the first application into the event information, to obtain the first event; and the first application framework inserts the first event into the content provider corresponding to the operating system in the feature recognition device, where the event information includes at least one of an event name, an event unique identifier, and an event parameter.

In this embodiment of this disclosure, the first application framework encapsulates the invocation for the predetermined interface by the first application as the first event, and then inserts the first event into the content provider. An encapsulation structure of the event information is roughly divided into three parts: the event name, the event unique identifier, and the event parameter.

Specifically, the event name is determined based on the predetermined interface invocation request, and indicates the first event. The content provider and the second application may determine a processing manner corresponding to the event through matching of the event name, that is, the content provider notifies the second application that the first event is inserted, and the second application starts detection on the feature data. In an example, because the first event is generated based on a request of the first application and is used by the first application to directly obtain object identity information of a user that enters the feature data, the event name of the first event may be GetOpenID.

The event unique identifier indicates information that is related to the currently entered feature data and that is about the first event, and is configured for distinguishing between feature data entered at different time into the same feature recognition device. In some embodiments, the event unique identifier may be determined based on at least one of the following: a timestamp at which the predetermined interface invocation request is received, a timestamp at which the first event is generated, and the like. In some embodiments, one or more timestamps may be directly used as an event unique identifier, or the one or more timestamps may be used, after certain calculation or adaptation, as the event unique identifier.

The event parameter indicates a parameter required for subsequent processing of the first event. During actual application, a person skilled in the art may set a specific parameter type and content according to an actual situation. This is not limited in this embodiment of this disclosure herein.

In an example, based on the event information of the first event, a structure in which the first application framework inserts the first event into the content provider may be shown as follows:
Event name: GetOpenID
Event unique identifier: Current timestamp
Event parameter: Optional

In this embodiment of this disclosure, operation S2031 may specifically include the following operations: The second application encapsulates the event information of the first event and the object identity information, to generate the second event; and the second application inserts the second event into the content provider, where the event information of the first event includes at least one of an event name and an event unique identifier.

In this embodiment of this disclosure, the second application encapsulates the event information of the first event and the object identity information as the second event, and then reversely inserts the second event into the content provider. An event name of the second event may directly use the event name of the first event, or the event name of the second event is different from the event name of the first event, and event information of the second event may include both the event name of the first event and the event name of the second event.

Similarly, an event unique identifier of the second event may directly use the event unique identifier of the first event, or the event unique identifier of the second event is different from the event unique identifier of the first event, and the event information of the second event may include both the event unique identifier of the first event and the event unique identifier of the second event. In some embodiments, the event unique identifier of the second event is determined based on at least one of the following: a timestamp at which the predetermined interface invocation request is received, a timestamp at which the first event is generated, a timestamp at which detection on the feature data starts, a timestamp at which the feature data is detected, a timestamp at which the second event is generated, and the like. In some embodiments, one or more timestamps may be directly used as the event unique identifier of the second event, or the one or more timestamps may be used, after certain calculation or adaptation, as the event unique identifier of the second event, or the event unique identifier of the first event and the event unique identifier of the second event may be calculated or adapted together and then may be used as the event unique identifier of the second event. This is not limited in this embodiment of this disclosure herein.

In an example, based on the event information and the obtained object identity information, a structure in which the second application inserts the second event into the content provider may be shown as follows:
Event name: GetOpenID
Event unique identifier: Timestamp generated during detection
Event parameter: OpenID (object identity information) of a user

In this embodiment of this disclosure, a high-efficient and secure channel is implemented by using the content provider. The channel enables the first application framework to actively obtain partial data of the second application.

In this embodiment of this disclosure, an event inserted into the content provider may be identified by using a URI, and the content provider can match and recognize, according to the URI, each event and a processing manner corresponding to the event.

To be specific, in this embodiment of this disclosure, operation S201 may further include the following operations: The first application framework identifies, by using a first uniform resource identifier (a first URI), the first event inserted into the content provider. The first uniform resource identifier (the first URI) is used by the content provider to recognize the first event, and transmit the notification that the first event is inserted into the content provider to the second application.

Similarly, operation S2031 may further include the following operations: The second application identifies, by using a second uniform resource identifier (a second URI), the second event inserted into the content provider. The second uniform resource identifier (the second URI) is used by the content provider to recognize the second event, and transmit the notification that the second event is inserted to the first application framework.

The uniform resource identifier (URI) is also referred to as a universal resource identifier.

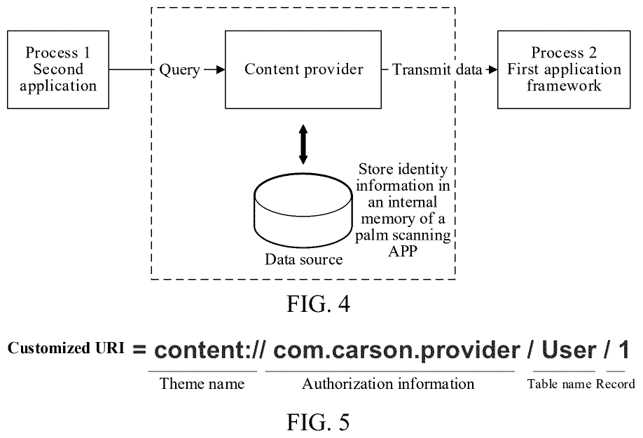

An example in which a feature recognition device carries an Android system is used, and the Android system defines a set of dedicated URIs (namely, Content URIs) according to a URI standard. A structural standard of a URI is shown in FIG. 5.

Theme name (Schema): A URI prefix theme name of the ContentProvider is Content.

Authorization information (Authority): The authorization information is a unique identifier authorized by the ContentProvider. For example, with reference to the first application framework (the WMPF is used as an example) and a processing process between the first application framework and the ContentProvider, authorization information of the first URI may be com.wmpf.cli.provider, and authorization information of the second URI may be com.wmpf.comm.provider.

Table name (Path): The ContentProvider points to a table name in a database. For example, with reference to the first application framework (the WMPF is used as an example) and the processing process between the first application framework and the ContentProvider, a table name to which the first URI points may be invokeChannelEvent (a registration detection event), and a table name to which the second URI points may be notifyInvokeChannelEvent (a reverse notification event occurs).

Record (ID): a record in the table (if no record is specified, return all records)

Based on a function of the ContentProvider and with reference to the first application framework (the WMPF is used as an example), standard URI structures that may be predetermined and that respectively identify the first event and the second event are:
content://com.wmpf.cli.provider/invokeChannelEvent, and
content://com.wmpf.comm.provider/notifyInvokeChannelEvent

In the embodiments of this disclosure, the feature recognition device may provide some functions for the device access party, including but not limited to:

### (1) Event Registration Function

The first application further has an event registration function. By registering a third event, the first application can initiate the predetermined interface invocation request, and receive the object identity information transmitted through the callback interface.

In an example, a pseudocode of the function is as follows:

```
  //register an event (the third event) with an event name of ‘GetOpenID’
  wmpf.Channel.registerEvent({
  event:‘GetOpenID’,
  success(res) {
  console.log(res)
  }
  })
  const callback=(res) => {
  //the second application triggers the third event of ‘GetOpenID’ after
obtaining an OpenID of a user that enters feature data, and transmits the
OpenID to the first application
  console.log(‘OpenID =’+res.data)
  }
```

In this embodiment of this disclosure, before the triggering, by the first application that is run in the feature recognition device, the predetermined interface invocation request, the method provided in this embodiment of this disclosure may further include the following operation: registering a third event for the first application.

### (2) Detection Enabling Function

The first application may further have a detection enabling function. Based on the function, a state of the third event may be set to a detection state, and the registered third event is detected. Only when the third event is in the detection state, the object identity information transmitted by the second application can be received.

In an example, a pseudocode of the function is as follows:

//detect a registered GetOpenID event
wmpf.Channel.on(‘GetOpenID’,callback)

In this embodiment of this disclosure, operation S203 specifically includes the following operations: If the third event is in the detection state, the second application determines, after detecting the feature data, the object identity information corresponding to the feature data, triggers the third event, and transmits the object identity information to the first application.

To be specific, after detecting the feature data only when the third event is in the detection state, the second application determines the object identity information corresponding to the feature data, and transmits the object identity information to the first application. If the third event is in a non-detection state, the second application may not perform these operations, to save computing resources.

### (3) Detection Cancellation Function

The first application may further have a detection cancellation function. Based on the function, the state of the third event may be set to the non-detection state, and the registered third event is not detected. When the third event is in the non-detection state, the object identity information transmitted by the second application cannot be received.

In an example, a pseudocode of the function is as follows:

//cancel detection on the registered ‘GetOpenID event
wmpf.Channel.off(GetOpenID’,callback)

The method provided in this embodiment of this disclosure may further include the following operation: changing the state of the third event to a detection cancellation state for the first application.

The detection enabling function and the detection cancellation function may be used in cooperation with each other. The device access party may customize effect-taking time of the detection enabling function and effect-taking time of the detection cancellation function. For example, detection is enabled each time a user uses the feature recognition device, and the detection is cancelled after the use is completed. For another example, detection is enabled and the detection is cancelled at start time and end time of a predetermined time period respectively, and the predetermined time period may be related to business hours, working hours, and the like. For yet another example, after the feature recognition device is started, detection is enabled, the feature recognition device remains in a detection state, and the detection cancellation function and the like are not used. This may be set by a person skilled in the art according to an actual situation. This is not limited in this embodiment of this disclosure herein.

### (4) Registration Cancellation Function

The first application may further have a registration cancellation function. The first application may cancel registration of the third event. In this case, the first application cannot initiate the predetermined interface invocation request, and cannot receive the object identity information transmitted through the callback interface.

In an example, a pseudocode of the function is as follows:

//cancel registration of the event with the event name of ‘GetOpenID
wmpf.Channel.unregisterEvent({
event:‘GetOpenID’,
success(res) {
console.log(res)
}
})

The method provided in this embodiment of this disclosure may further include the following operation: cancelling registration of the third event for the first application.

The event registration function and the registration cancellation function may also be used in cooperation with each other. The device access party may customize effect-taking time of the event registration function and effect-taking time of the registration cancellation function. For details, reference may be made to the descriptions in which the detection enabling function and the detection cancellation function are used in cooperation with each other. Details are not described herein again.

In at least one of the foregoing embodiments, the feature recognition device may be specifically the palm scanning device. Compared with another feature recognition device such as the face scanning device, the palm scanning device is more adaptive to the solutions of the embodiments of this disclosure. This is because in comparison with a case in which face shielding or a plurality of faces may exist in the face scanning device, due to a feature of the palm scanning device, there are fewer features that may be mistakenly recognized in a palm scanning area, a necessity of reconfirmation is lower, and a security index is higher. Therefore, both identity authentication and service login of the device access party may be implemented through only one time of palm scanning.

In addition, compared with a fingerprint recognition technology, cheating is less likely to occur in a palm recognition technology. A finger print and the like may be changed due to some physical factors, environmental factors, and other factors, and palm scanning recognition may be more stable.

In the embodiments of this disclosure, the palm scanning device may provide the device access party with a capability of directly opening a third-party program (the first application) on the palm scanning device in an environment away from a predetermined application client. Specifically, a predetermined interface “wmpf.Channel.on (‘GetOpenID’, callback)” is provided for the device access party. After the first application registers corresponding event detection, provided that the predetermined interface is invoked, the first application can directly obtain an OpenID of a palm-scanning user. The user does not need to log in to a mini program by scanning a code.

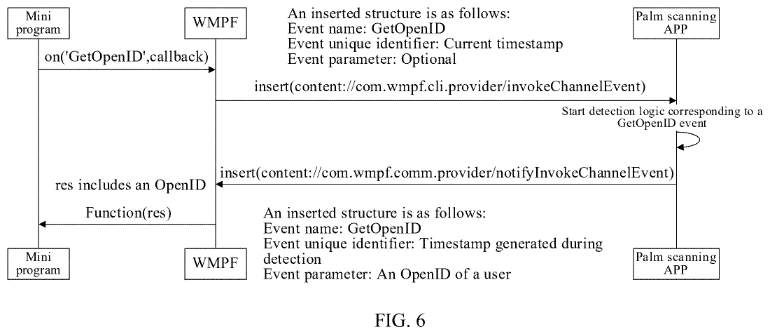

The following describes a complete invoking process from an IoT mini program that is run in the WMPF to a palm scanning APP by using an example in which the palm scanning device carries the Android system, the first application is the IoT mini program, the first application framework is the WMPF, and the second application is the palm scanning APP. As shown in FIG. 6, after the mini program invokes the predetermined interface “wmpf.Channel.on (‘GetOpenID’, callback)”, sequential invocation shown in FIG. 6 is performed as follows:

6.1: Transmit an invocation request “wmpf.Channel.on (‘GetOpenID’, callback)” triggered by the mini program to the WMPF.

6.2: The WMPF encapsulates the current invocation for the predetermined interface as an event (namely, the first event), and inserts the event into the ContentProvider, that is, performs an operation on the ContentProvider:
insert(content://com.wmpf.cli.provider/invokeChannelEvent)

An encapsulation structure may be roughly divided into three parts: an event name, an event unique identifier, and an event parameter.

6.3: The ContentProvider notifies the palm scanning APP that the event is inserted, and the palm scanning APP may extract information such as an event name according to the inserted first event, start detection logic corresponding to the GetOpenID event, and start detection on palm scanning data.

6.4: After an OpenID of a current palm-scanning user is successfully obtained through palm scanning, the palm scanning APP reversely inserts an event (namely, the second event), that is, performs an operation on the ContentProvider:
insert(content://com.wmpf.comm.provider/notifyInvokeChannelEvent)

A corresponding event name, the event unique identifier in operation 6.2, and the OpenID of the user are encapsulated.

6.5: The ContentProvider notifies the WMPF that the event (the second event) is inserted, and the WMPF may extract information such as the event name according to the inserted second event, and obtain the OpenID of the palm-scanning user.

6.6: The WMPF transmits the obtained OpenID to the mini program according to a return value res, where the res includes the OpenID, that is, ‘OpenID=’+res.data.

In this way, the whole process in which the mini program obtains the user identity (OpenID) of the palm-scanning user is completed. A reliability problem of logging in to the mini program is resolved, user information security is ensured, and an operation process in which a user needs to actively scan a code again is avoided.

In the technical solutions of the embodiments of this disclosure, the ContentProvider specific in the Android is used as an underlying bridge, and through an interface protocol that is for obtaining a user identity through palm scanning and that is agreed on with a hardware framework (WMPF) of the IoT mini program, a capability of the mini program developed by the device access party to obtain the user identity from a palm scanning service side is implemented. That is, the mini program only needs to invoke the special interface, to actively obtain the user identity of the current palm-scanning user from the palm scanning service side at a layer of the mini program. Login is completed without relying on the palm-scanning user to manually scan a code again.

The technical solutions in the embodiments of this disclosure can resolve two pain points at one time:

(1) The mini program can directly and accurately obtain, through the new interface, identity information of the palm-scanning user, to ensure user information security, and avoid a palm scanning failure caused by an error in obtaining the user identity information.

(2) For the palm-scanning user, an operation of scanning the code again to log in after palm scanning is omitted, thereby greatly simplifying a use process of the palm-scanning user, and optimizing use experience.

The technical solutions in the embodiments of this disclosure may be applied to a related scenario. The IoT mini program that is run on the palm scanning device is an independent environment, and does not interfere with another service capability of the device.

The technical solutions in the embodiments of this disclosure may also be applied to a scenario of a specific palm scanning service, for example, a scenario such as a gym palm scanning access control or a palm scanning device self-service cashier. Because these service parties are usually equipped with mini programs, the capability, supported by the solutions, of directly obtaining identity information of the palm-scanning user from the IoT mini program enables a device access party to obtain the identity of the palm-scanning user is recognized from a mini program, so as to serve a service scenario of the device access party provided that the mini program of the device access party is developed.

In some embodiments, information processing involved in the embodiments of this disclosure may be implemented based on a cloud technology. The cloud technology is a hosting technology that unifies a series of resources such as hardware, software, and networks in a wide area network or a local area network to implement computing, storage, processing, and sharing of data. The cloud technology is a collective term for a network technology, an information technology, an integration technology, a management platform technology, an application technology, and the like applied based on a cloud computing business mode, and may form a resource pool, which is used as required, and is flexible and convenient. A cloud computing technology is becoming an important support. Cloud computing refers to a delivery and use mode of an IT infrastructure, and refers to obtaining a required resource via a network in an on-demand and easily extensible manner. Cloud computing in a broad sense refers to a delivery and use mode of a service, and refers to obtaining a required service via a network in an on-demand and easily extensible manner. Such a service may be related to IT, software, and the Internet, or may be another service. Cloud computing has developed rapidly with development of the Internet, a real-time data stream, and diversification of connection devices, and promotion of a demand for a search service, a social network, mobile business, and open collaboration. Unlike previous parallel distributed computing, generation of the cloud computing drives revolutionary reform of an entire Internet mode and an enterprise management mode from ideas.

The database involved in the embodiments of this disclosure may be briefly considered as an electronic file cabinet, that is, a place where electronic files are stored. A user may perform an operation such as add, query, update, or delete on data in the files. The so-called “database” is a data set that is stored together in a particular manner, can be shared with a plurality of users, has as low redundancy as possible, and is independent of an application.

In some embodiments, some operations, for example, feature recognition, of the information processing method provided in the embodiments of this disclosure may be implemented based on an artificial intelligence (AI) technology. AI is a theory, a method, a technology, and an application system that uses a digital computer or a machine controlled by the digital computer to simulate, extend, and expand human intelligence, perceive an environment, acquire knowledge, and use the knowledge to obtain a best result. In other words, the artificial intelligence is a comprehensive technology of computer science, attempts to understand an essence of intelligence, and produces a new intelligent machine that can react in a manner similar to human intelligence. The artificial intelligence is to study design principles and implementation methods of various intelligent machines, to cause the machines to have functions of perception, reasoning, and decision-making. The solutions may involve fields such as a computer vision (CV) technology and a machine learning technology of artificial intelligence software technologies.

Computer vision technology includes a science of studying how to cause a machine to “see”, and further, refers to replacing human eyes with a camera and a computer to perform machine vision such as recognition and measurement on a target, and further performing graphic processing, so that the computer processes the target into an image more suitable for the human eyes to observe or an image transmitted to an instrument for detection. As a scientific discipline, the computer vision studies related theories and technologies and attempts to establish an artificial intelligence system that can obtain information from images or multi-dimensional data. The computer vision technology generally includes technologies such as image processing, image recognition, image semantic understanding, image retrieval, optical character recognition (OCR), video processing, video semantic understanding, video content/behavior recognition, three-dimensional object reconstruction, a 3D technology, virtual reality, augmented reality, simultaneous positioning and map construction, autonomous driving, and intelligent transportation, and further includes common biometric feature recognition technologies such as a face recognition technology, a fingerprint recognition technology, and a palm recognition technology.

Machine learning (ML) includes a multi-field interdiscipline, and relates to a plurality of disciplines such as a probability theory, statistics, an approximation theory, convex analysis, and an algorithm complexity theory. The machine learning specifically studies how a computer simulates or implements a human learning behavior to obtain new knowledge or a new skill, and reorganizes an existing knowledge structure, so that performance of the computer is continuously improved. The machine learning is a core of the artificial intelligence and a fundamental way to make the computer intelligent, and is applied to various fields of the artificial intelligence. The machine learning and deep learning generally include technologies such as an artificial neural network, a belief network, reinforcement learning, transfer learning, inductive learning, and learning from demonstration.

With the study and advancement of the artificial intelligence technology, the artificial intelligence technology is studied and applied in a plurality of fields, such as a common smart home, smart wearing device, virtual assistant, smart speaker, smart marketing, unmanned driving, self-driving, drone, robot, smart healthcare, smart customer service, Internet of vehicles, and intelligent transportation. It is believed that as the technology develops, the artificial intelligence technology will be applied in more fields and exert an increasingly important value.

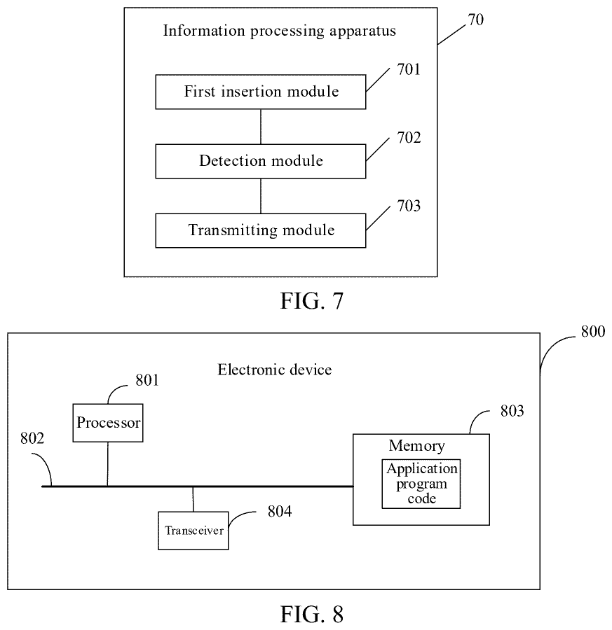

An embodiment of this disclosure provides an information processing apparatus, running on a feature recognition device. A first application and a second application are run in the feature recognition device, a first application framework is provided, and the first application framework provides a running environment of the first application. As shown in FIG. 7, the information processing apparatus 70 may include: a first insertion module 701, a detection module 702, and a transmitting module 703.

The first insertion module 701 is configured to insert, in response to a predetermined interface invocation request triggered by the first application, a first event generated based on the predetermined interface invocation request into a content provider corresponding to an operating system in the feature recognition device.

The detection module 702 is configured to determine, after receiving a notification that the first event is inserted and that is generated in the content provider, event information of the first event from the content provider, and detect feature data based on the event information.

The transmitting module 703 is configured to determine, after the feature data is detected, object identity information corresponding to the feature data, and transmit the object identity information to the first application.

In some embodiments, the apparatus further includes: a second insertion module 704.

When the transmitting module 703 is configured to transmit the object identity information to the first application,
the second insertion module 704 is configured to insert a second event generated based on the object identity information into the content provider.

The transmitting module 703 is specifically configured to extract, after receiving a notification that the second event is inserted into the content provider, the object identity information from the second event, and transmit the object identity information to the first application.

In some embodiments, when being configured to insert the second event generated based on the object identity information into the content provider, the second insertion module 704 is specifically configured to:
encapsulate the event information of the first event and the object identity information, to generate the second event; and
insert the second event into the content provider,
the event information of the first event including at least one of an event name and an event unique identifier.

In some embodiments, when being configured to insert the first event generated based on the predetermined interface invocation request into the content provider corresponding to the operating system in the feature recognition device, the first insertion module 701 is specifically configured to:
encapsulate invocation for a predetermined interface by the first application into the event information, to obtain the first event; and
insert the first event into the content provider corresponding to the operating system in the feature recognition device,
the event information including at least one of an event name, an event unique identifier, and an event parameter.

In some embodiments, the apparatus further includes: a first identification module 705.

When the first insertion module 701 is configured to insert the first event generated based on the predetermined interface invocation request into the content provider corresponding to the operating system in the feature recognition device,
the first identification module 705 is configured to identify, by using a first uniform resource identifier, the first event inserted into the content provider, the first uniform resource identifier being used by the content provider to recognize the first event, and generate the notification that the first event is inserted into the content provider and transmit the notification that the first event is inserted into the content provider to the second application.

In some embodiments, the apparatus further includes: a second identification module 706.

When the second insertion module 704 is configured to insert the second event generated based on the object identity information into the content provider,
the second identification module 706 is configured to identify, by using a second uniform resource identifier, the second event inserted into the content provider, the second uniform resource identifier being used by the content provider to recognize the second event, and generate the notification that the second event is inserted and transmit the notification that the second event is inserted to the first application framework.

In some embodiments, when being configured to determine, after the feature data is detected, the object identity information corresponding to the feature data, and transmit the object identity information to the first application, the transmitting module 703 is specifically configured to:
determine, after the feature data is detected, the object identity information corresponding to the feature data, and call back the first application through a callback interface, to transmit the object identity information to the first application.

In some embodiments, the event unique identifier is determined based on at least one of the following:
a timestamp at which the predetermined interface invocation request is received;
a timestamp at which the first event is generated;
a timestamp at which detection on the feature data starts;
a timestamp at which the feature data is detected; and
a timestamp at which the second event is generated.

In some embodiments, the apparatus further includes: a registration module 707.

Before the first application that is run in the feature recognition device triggers the predetermined interface invocation request, the registration module 707 is configured to register a third event for the first application, the third event being configured for enabling the first application to initiate the triggered predetermined interface invocation request and receive the object identity information transmitted through the callback interface.

In some embodiments, when being configured to determine, after the feature data is detected, the object identity information corresponding to the feature data, and transmit the object identity information to the first application, the transmitting module 703 is specifically configured to:
determine, if the third event is in a detection state and after the feature data is detected by the second application, the object identity information corresponding to the feature data, trigger the third event, and transmit the object identity information to the first application through the callback interface.

In some embodiments, the apparatus further includes: at least one of a detection cancellation module 708 and a registration cancellation module 709.

The detection cancellation module 708 is configured to change a state of the third event to a detection cancellation state for the first application.

The registration cancellation module 709 is configured to cancel registration of the third event for the first application.

In an example implementation, the feature recognition device is a palm scanning device.

In an example implementation, the first application is an IoT mini program.

The first insertion module 701 and the first identification module 705 run in cooperation with the first application framework. The detection module 702, the second insertion module 704, and the second identification module 706 run in cooperation with the second application. The registration module 707, the detection cancellation module 708, and the registration cancellation module 709 run in cooperation with the first application.

The apparatus in this embodiment of this disclosure may perform the method provided in the embodiments of this disclosure, and implementation principles of the apparatus and the method are similar. The actions performed by modules in the apparatus in this embodiment of this disclosure correspond to the operations in the method in the embodiments of this disclosure. For detailed functional descriptions of the modules of the apparatus and beneficial effects achieved by the modules, reference may be made to the descriptions of the corresponding method shown above, and details are not described herein again.

An embodiment of this disclosure provides an electronic device, including a memory, a processor, and a computer program stored on the memory, the processor executing the computer program to implement the operations of the foregoing method embodiments.

The electronic device may be a feature recognition device, for example, a palm scanning device.

An embodiment provides an electronic device. As shown in FIG. 8, an electronic device 800 includes: a processor 801 and a memory 803. The processor 801 is connected to the memory 803, for example, through a bus 802. In some embodiments, the electronic device 800 may further include a transceiver 804. The transceiver 804 may be configured to perform data exchange between the electronic device and another electronic device, such as data transmitting and/or data receiving. During actual application, a quantity of transceivers 804 is not limited to one. The structure of the electronic device 800 does not constitute a limitation on this embodiment of this disclosure.

The processor 801 is an example of processing circuitry and may be a central processing unit (CPU), a general-purpose processor, a digital signal processor (DSP), an application specific integrated circuit (ASIC), a field programmable gate array (FPGA) or another programmable logic device, a transistor logic device, a hardware component, or any combination thereof. The processor 801 may implement or execute various examples of logic blocks, modules, and circuits described with reference to the content disclosed in this disclosure. Alternatively, the processor 801 may be a combination that implements a computing function, for example, a combination of one or more microprocessors, or a combination of a DSP and a microprocessor.

The bus 802 may include a path for transmitting information between the foregoing components. The bus 802 may be a peripheral component interconnect (PCI) bus, an enhanced industry standard architecture (EISA) bus, or the like. The bus 802 may be classified into an address bus, a data bus, a control bus, and the like. For ease of representation, only one bold line is used to represent the bus in FIG. 8, but this does not indicate that there is only one bus or only one type of bus.

The memory 803 may be a read-only memory (ROM) or another type of static storage device that may store static information and instructions, a random access memory (RAM) or another type of dynamic storage device that may store information and instructions, an electrically erasable programmable read-only memory (EEPROM), a compact disc read-only memory (CD-ROM) or another optical disc storage, an optical disk storage (including a compact disk, a laser disk, an optical disk, a digital versatile disc, a blu-ray disc, and the like), a magnetic disk storage medium, another magnetic storage device, or any other medium that can be configured to carry or store a computer program and can be read by a computer. This is not limited herein.

The memory 803 is configured to store a computer program for performing the embodiments of this disclosure, and the performing is controlled and executed by the processor 801. The processor 801 is configured to execute the computer program stored in the memory 803, to implement the operations shown in the foregoing method embodiments.

An embodiment of this disclosure provides a computer-readable storage medium, such as a non-transitory computer-readable storage medium. The computer-readable storage medium stores a computer program. When a computer program is executed by a processor, the operations and corresponding content of the foregoing method embodiments may be implemented.

An embodiment of this disclosure further provides a computer program product, including a computer program. When the computer program is executed by a processor, the operations and corresponding content of the foregoing method embodiments may be implemented.

In the specification, claims, and accompanying drawings of this disclosure, the terms “first”, “second”, “1”, “2”, and so on are intended to distinguish between similar objects rather than describe a specific order or sequence. Data used in this manner is interchangeable in appropriate cases, so that the embodiments of this disclosure described herein can be implemented in an order other than the order illustrated or described.

Although various operations are indicated by arrows in the flowcharts of the embodiments of this disclosure, the order in which the operations are implemented is not limited to the order indicated by the arrows. In some implementation scenarios of the embodiments of this disclosure, the implementation operations in the flowcharts may be performed in another order according to a requirement, unless clearly specified herein. In addition, some or all of the operations in the flowcharts may include a plurality of sub-operations or a plurality of stages based on an actual implementation scenario. Some or all of these sub-operations or stages may be performed at the same time, and each of the sub-operations or stages may be performed at different times respectively. A performing order of these sub-operations or stages may be flexibly configured according to a requirement in a scenario in which performing times are different, which is not limited in the embodiments of this disclosure.

The foregoing descriptions are merely examples implementations of some implementation scenarios of this disclosure. Other similar implementations based on the technical idea of this disclosure are within the scope of the embodiments of this disclosure.

What is claimed is:

1. An information processing method, comprising:
inserting, by an first application framework in response to an interface invocation request from a first application, a first event generated based on the interface invocation request into an event interface corresponding to an operating system in a feature recognition device, the first application framework being configured to provide a running environment for the first application; and
providing, by the first application framework, object identity information from the event interface to the first application, the object identity information corresponding to feature data that is obtained by a second application based on event information of the first event.

2. The information processing method according to claim 1, wherein
the event interface is a cross-application data sharing interface, and
the feature data includes biometric information of a user.

3. The information processing method according to claim 1, wherein:
a second event that is generated by the second application based on the object identity information is inserted into the event interface; and
the providing comprises:
extracting, by the first application framework, the object identity information from the second event, and
providing, by the first application framework, the object identity information to the first application.

4. The information processing method according to claim 3, wherein
the second event is inserted into the event interface by the second application,
the event information of the first event includes at least one of an event name or an event unique identifier.

5. The information processing method according to claim 1, wherein the inserting the first event comprises:
encapsulating, by the first application framework, invocation for a predetermined interface by the first application into the event information, to obtain the first event; and
inserting, by the first application framework, the first event into the event interface corresponding to the operating system in the feature recognition device,
the event information including at least one of an event name, an event unique identifier, or an event parameter.

6. The information processing method according to claim 1, wherein the inserting the first event comprises:
identifying, by the first application framework using a first uniform resource identifier, the first event inserted into the event interface, the first uniform resource identifier being used by the event interface to identify the first event, and generate a notification that the first event is inserted into the event interface and provide the notification that the first event is inserted into the event interface to the second application.

7. The information processing method according to claim 3, wherein
a second uniform resource identifier is used by the event interface to identify the second event, and generate a notification that the second event is inserted and provide the notification that the second event is inserted to the first application framework.

8. The information processing method according to claim 1, wherein
the object identity information corresponding to the feature data is inserted into the event interface by the second application via a callback interface.

9. The information processing method according to claim 4, wherein
the event information includes the event unique identifier, and
the event unique identifier is determined based on a timestamp that is associated with the interface invocation request.

10. The information processing method according to claim 1, further comprising:
registering a third event for the first application, the third event enabling the first application to initiate the interface invocation request and receive the object identity information; and
when the third event is in a detection state, the object identity information corresponding to the feature data is determined by the second application, the third event is triggered, and the object identity information is provided to the first application.

11. The information processing method according to claim 1, wherein the feature recognition device is a biometric scanning device.

12. The information processing method according to claim 1, wherein the first application is an Internet of Things (IoT) mini program.

13. An information processing apparatus, comprising:
processing circuitry configured to:
insert, via an first application framework in response to an interface invocation request from a first application, a first event generated based on the interface invocation request into an event interface corresponding to an operating system in a feature recognition device, the first application framework being configured to provide a running environment for the first application; and
provide, via the first application framework, object identity information from the event interface to the first application, the object identity information corresponding to feature data that is obtained by a second application based on event information of the first event.

14. The information processing apparatus according to claim 13, wherein
the event interface is a cross-application data sharing interface, and
the feature data includes biometric information of a user.

15. The information processing apparatus according to claim 13, wherein:
a second event that is generated by the second application based on the object identity information is inserted into the event interface; and
the processing circuitry is configured to:
extract, via the first application framework, the object identity information from the second event, and
provide, via the first application framework, the object identity information to the first application.

16. The information processing apparatus according to claim 15, wherein
the second event is inserted into the event interface by the second application,
the event information of the first event includes at least one of an event name or an event unique identifier.

17. The information processing apparatus according to claim 13, wherein the processing circuitry is configured to:
encapsulate, via the first application framework, invocation for a predetermined interface by the first application into the event information, to obtain the first event; and
insert, via the first application framework, the first event into the event interface corresponding to the operating system in the feature recognition device,
the event information including at least one of an event name, an event unique identifier, or an event parameter.

18. The information processing apparatus according to claim 13, wherein the processing circuitry is configured to:
identify, via the first application framework using a first uniform resource identifier, the first event inserted into the event interface, the first uniform resource identifier being used by the event interface to identify the first event, and generate a notification that the first event is inserted into the event interface and provide the notification that the first event is inserted into the event interface to the second application.

19. A non-transitory computer-readable storage medium storing instructions which when executed by a processor cause the processor to perform:
inserting, by an first application framework in response to an interface invocation request from a first application, a first event generated based on the interface invocation request into an event interface corresponding to an operating system in a feature recognition device, the first application framework being configured to provide a running environment for the first application; and
providing, by the first application framework, object identity information from the event interface to the first application, the object identity information corresponding to feature data that is obtained by a second application based on event information of the first event.

20. The non-transitory computer-readable storage medium according to claim 19, wherein
the event interface is a cross-application data sharing interface, and
the feature data includes biometric information of a user.
